(19) United States
(12) Patent Application Publication
(10) Pub. No.: US 2002/0129361 A1
(43) Pub. Date: Sep. 12, 2002

(54) Information service system, information supply terminal used in this system, information service method, and program for information supply terminal

(76) Inventors: Setsuo Arita, Hitachiota (JP); Katsuhiko Sagae, Hitachinaka (JP)

Correspondence Address: DICKSTEIN SHAPIRO MORIN & OSHINSKY LLP, 2101 L STREET NW, WASHINGTON, DC, 20037-1526, US

(21) Appl. No.: 09/940,789

(22) Filed: Aug. 29, 2001

(30) Foreign Application Priority Data
Mar. 9, 2001 (JP) 2000-066430

(51) Int. Cl. H04N 7/16; H04H 9/00; G06F 3/00; H04N 5/445; G06F 13/00

(52) U.S. Cl. 725/23; 725/9; 725/46; 725/14

(57) ABSTRACT

An information service system in which information is collected, on a public communication network, from viewers who watch television programs and points are awarded to the viewers in accordance with the collected information, and which is constituted by an interest information generating portion for inputting individual audience result information generated as a result of the viewed television programs into information supply terminals existing on the public communication network to thereby generate individual interest information on the basis of the individual audience result information, an interest information input portion for receiving the individual interest information generated as a result of the viewed television programs from the information supply terminals, a file managing portion for managing an individual interest information file, and a point awarding portion for awarding points to the viewers in according to supply of the individual audience result information, and so on, from the viewers.

### BACKGROUND OF THE INVENTION

The present invention relates to an information service system for collecting information on a predetermined network from individuals who watch media programs and for awarding points to the individuals in accordance with the collected information; an information supply terminal used in the information service system; an information service method; and an information supply terminal program.

Just as the saying “those who control the marketing information control the market” is, when the undertakers or the like desire to sell products or to make business plans, it is very important for them to acquire correct consumer information. Questionnaires may be representative means for obtaining consumer information. In order to obtain high quality information from the questionnaires, it is important to encourage the respondents to answer the questionnaires and to increase the number of respondents. To achieve the above objects, gifts, points, or the like, are given to the respondents in reward for answering the questionnaires. For example, JP-A-10-171880 discloses a “Point Managing Apparatus” in which points are awarded to the respondents who make access to the homepage on Internet where the questionnaire is located and who answer the questionnaire. Further, JP-A-2000-151858 discloses a “Telephone Answer Collecting System Coupled to Telephone Charge Adjustment System” in which points (points for discounting telephone charge) are given to the respondents who answer the questionnaire on the telephone (voice answer back).

Recently, people can obtain information such as various kinds of domestic or foreign news, or information in different fields such as sport, education, or documentary, on television broadcasting. Further, since satellite broadcasting is also being performed, people are expected to obtain increasing kinds of broadcast information. Under such a circumstance, people are bothered to select individual interesting information out of a large number of kinds of TV broadcast information, especially when a lot of uninteresting information is also included. As means for solving such a problem, there is known “Information Service System and Broadcasting Reception System” as disclosed in JP-A-6-124309 filed by the present applicant. This technique classifies and sorts a channel selection history of television programs for each user in accordance with a certain classification, comprehends each user's favorite programs, and automatically selects and supplies a program to the user in accordance with the comprehended information.

### SUMMARY OF THE INVENTION

However, like the technique disclosed in JP-A-10-171880 and JP-A-2000-151858, when personal information is to be collected from questionnaires, in most cases, it is not easy to respond to the questionnaires, even if points are awarded to the respondents to encourage them to answer. Particularly, when the questionnaire enforcer desires to obtain more information from the respondents, or when the questionnaire enforcer desires to probe the answers more deeply, the questionnaire becomes difficult for the respondent to answer. This results in different answers or wrong answers which are not made by the respondents in the usual case. Further, it takes time for the respondent to answer the questionnaire. On this occasion, if the respondent does not have time, he/she may make wrong answers without understanding the contents of the questionnaire correctly, or make vague answers with point award in view. In short, not only cannot the questionnaire enforcer obtain correct information, in other words, valuable information, but also the incentive points are vain. On the other hand, it is burdensome and troublesome for the questionnaire enforcer, for example, to offer service on the basis of the false information. Further, to the questionnaire enforcer, questionnaire generation is a hard work. For example, even such a simple question that “what are you interested in?” is to be designed to be asked of the respondent, the content of the question has to be investigated sufficiently otherwise the questionnaire enforcer cannot obtain an honest answer.

Further, in the technique disclosed in JP-A-6-124309, the function performed on the basis of the information obtained as the results of the viewed television programs is automatic television channel selection. In order to carry out other functions than the above function, there is a problem that interest information (content) other than that for television programs has to be obtained newly from the information source. Further, in the technique, no investigation has been made into the point that individual interest information obtained as the result of the viewed television programs is utilized aggressively to thereby offer service beneficial to individual. That is, no attention is paid sufficiently to the individual interest information which is a very valuable information for marketing.

Further, the technique disclosed in JP-A-6-124309 did not pay sufficient attention to explosive spread and wide band of Internet, and to diversification of television programs and multi-channel achieved by BS (broadcasting Satellite) broadcasting, CS (Communication Satellite) broadcasting, and CATV (Cable Television) broadcasting.

Therefore, a primary object of the present invention is to provide an information service system in which information obtained incidentally from individual viewing (or browsing) of media programs can be utilized to the utmost, an information supply terminal used in this system, an information service method, and a program for the information supply terminal.

In order to achieve the above object, the present inventors have made researches diligently. As a result, the present inventors have reached a sufficient understanding of the value of the information obtained incidentally from individual watching of media programs and have completed the present invention by paying attention to the drawbacks of the conventional questionnaire research.

That is, according to a first aspect of the present invention, there is provided an information service system in which information is collected on a predetermined network from individuals who watch media programs and points are awarded to the individuals in accordance with to the collected information.

Further, according to a second aspect of the present invention, there is provided an information supply terminal for supplying information to the information service system.

Further, according to a third aspect of the present invention, there is provided an information method in which information is collected from individuals who watch media programs and points are awarded to the individuals in accordance with the collected information.

Further, according to a fourth aspect of the present invention, there is provided a program for the information supply terminal.

### BRIEF DESCRIPTION OF THE DRAWINGS

FIG. 1 is a diagram showing the whole configuration of an information service system according to an embodiment of the present invention;

FIG. 2 is a block diagram of an information supply terminal constituted by a personal computer in FIG. 1;

FIG. 3 is a logic configuration diagram of individual audience result information in FIG. 2;

FIG. 4 is a logic configuration diagram of individual interest information in FIG. 2;

FIG. 5 is a block diagram of the television set and the information supply terminal constituted by an exclusive communication terminal in FIG. 1;

FIG. 6 is a logic configuration diagram of individual interest information in FIG. 1;

FIG. 7 is a logic configuration diagram of aggregate audience result information in FIG. 1;

FIG. 8 is a diagram for explaining a mode of the information service in FIG. 1;

FIG. 9 is a sequence diagram for explaining the mode of the information service in detail;

FIG. 10 is a sequence diagram for explaining a processing flow of the information service;

FIG. 11 is a diagram for explaining the configuration of an information transmission screen of the information supply terminal in FIG. 1; and

FIG. 12 is a diagram for explaining the configuration of a point-award information display screen of the information supply terminal.

### DESCRIPTION OF THE EMBODIMENTS

An embodiment of the present invention will be described below in detail with reference to the drawings.

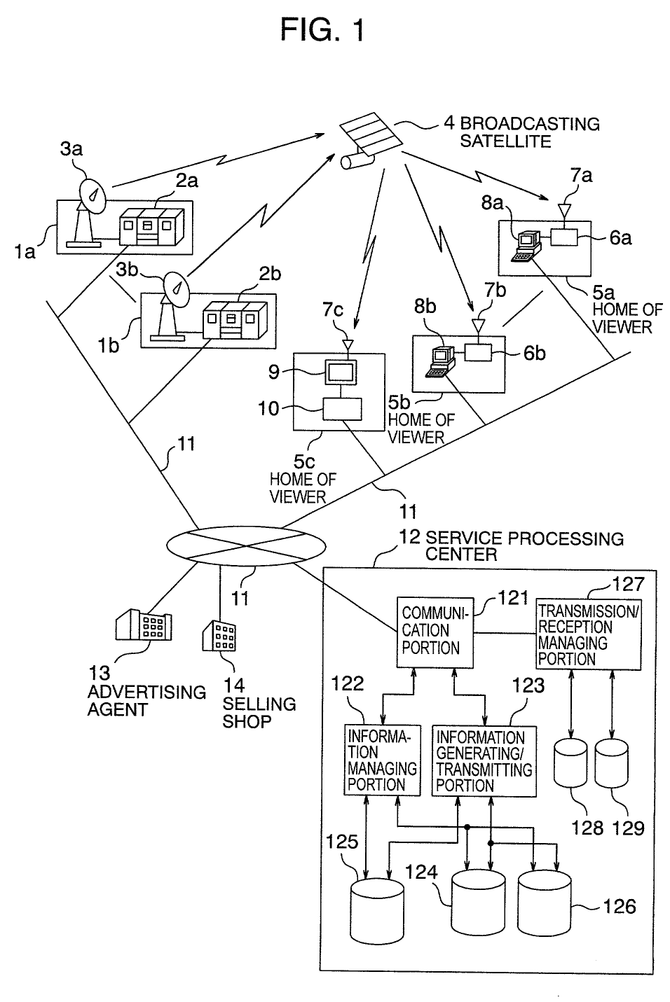

FIG. 1 is a diagram showing the whole configuration of an information service system according to an embodiment.

First, the information service system (information service method) in this embodiment is described. The business model by use of the information service system is carried out among (1) an undertaker (service processing center 12), (2) viewers (information supply terminals 8 and 10), and (3) information users (broadcasting stations 1, an advertising agent 13, and a selling shop 14). In the business model, information is collected from the viewers watching television programs on a public communication network (Internet) 11, points are awarded to the viewers in accordance with the collected information, and the collected information is supplied to the information users on the public communication network 11. Incidentally, assume that the information users have information using terminals not shown.

Among them, the service processing center 12 plays the core role of the business model in the information service system. The viewers watch media programs (hereinafter referred to as “television programs”) broadcast by the broadcasting stations 1, supply information obtained from the watching results of the viewers to the service processing center 12 and obtain points. The service processing center 12 suitably processes the information collected from the viewers (information received from the viewers) and supplies the processed information to the broadcasting stations 1. The service processing center 12 is paid from the broadcasting stations 1 for the information supply. Further, the service processing center 12 suitably processes information obtained from the viewers and supplies the processed information to the advertising agent 13 and the selling shop 14. The service processing center 12 is also paid from the advertising agent 13 and the selling shop 14 for the information supply. The advertising agent 13 and the selling shop 14 offer the viewers products or services for sale which are useful for the viewers. The viewers purchase the products or receive the services from the selling shop 14. On this occasion, the viewers may use the awarded points if it is necessary. Further, the advertising agent 13 develops its unique business to the broadcasting stations 1 and the selling shop 14. Incidentally, description of the embodiment will be made about the case where the information supply terminals 8 and 10, and so on are contained in the information service system.

Next, the whole configuration of the information service system in the embodiment is described.

As shown in FIG. 1, the information service system in the embodiment is constituted by a plurality of broadcasting stations 1 (1a, 1b), antennas 7 (7a, 7b, 7c) of viewers' homes 5 (5a, 5b, 5c), tuners 6 (6a, 6b), information supply terminals 8 (8a, 8b) constituted by personal computers, a television set 9, an information supply terminal 10 constituted by an exclusive communication terminal, a public communication network 11, a service processing center 12, an advertising agent 13, a selling shop 14, and a broadcasting satellite 4 such as a HEO (Highly Elliptical Orbit) satellite. Incidentally, if broadcast wave is distributed to the viewers' homes 5 over the broadcasting satellite 4, the broadcast wave can be well received even through the viewers' homes 5 are located in the regions among mountains. Incidentally, the television set 9 and the television tuners 6 of the viewers' homes 5 may be used in the satellite broadcasting or in surface wave broadcasting where the surface wave broadcasting can be received from surface wave broadcasting stations not shown.

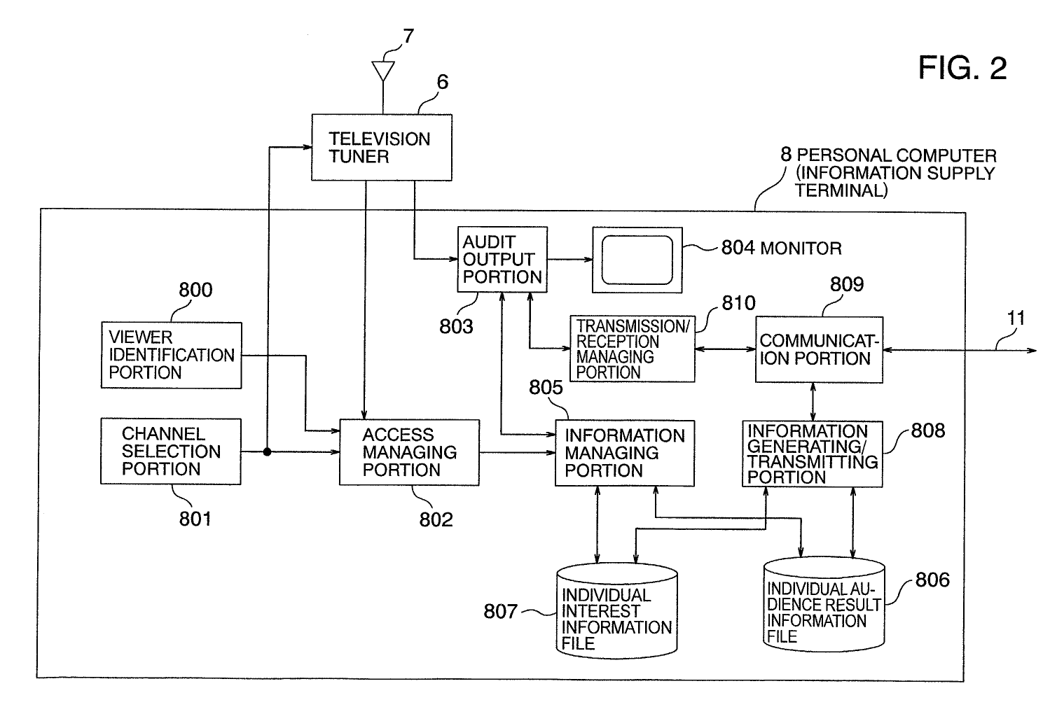

Through up-link transmission antennas 3 (3a, 3b), the broadcasting stations 1 (1a, 1b) transmit transmission signals, which are supplied from the broadcasting systems 2 (2a, 2b) respectively, as broadcast wave in a specific frequency to the broadcasting satellite 4. The broadcasting systems 2 generally supply the transmission signals in accordance with the scheduled programs. The broadcast wave transmitted through the broadcasting satellite 4 is received by the antennas 7 of the viewers' homes 5. FIG. 2 is applicable to both the case where the personal computers 8 are connected to the tuners 6 and personal computer screens are used to view the television programs and the case where television programs are viewed on the television set 9.

### Information Supply Terminal Constituted by Personal Computer

Description will be made about the information supply terminals 8 constituted by personal computers with reference to FIGS. 1 through 4.

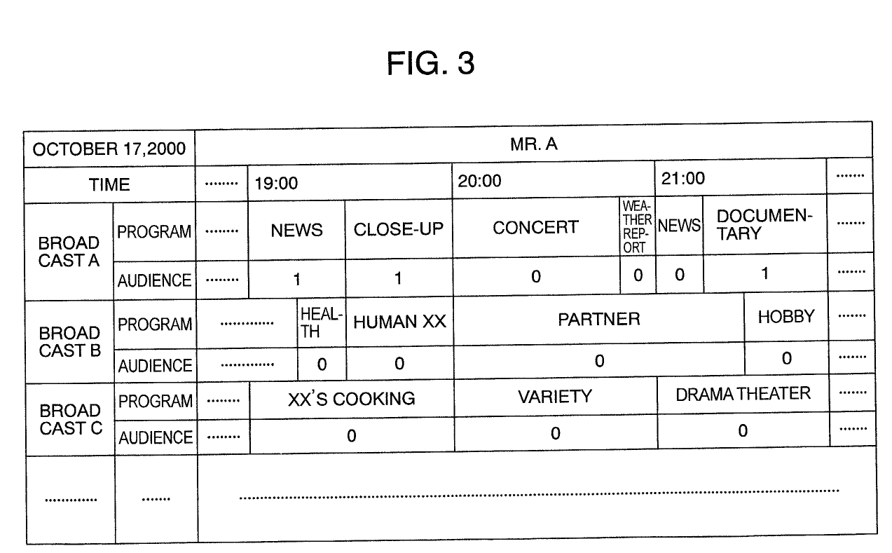

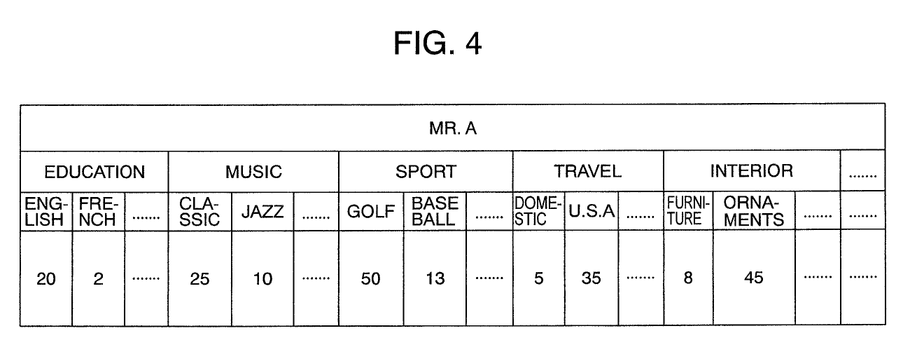

FIG. 2 shows a block diagram of the information supply terminal constituted by a personal computer. FIG. 3 shows a logic configuration diagram of individual audience result information. FIG. 4 shows a logic configuration diagram of individual interest information.

Each of the information supply terminals 8 plays a role as a terminal in the information service system in which information is collected on the public communication network 11 from the viewers watching television programs and points are awarded to the viewers in accordance with the collected information, and at the same time, in which the collected information is supplied to the information users on the public communication network 11. Accordingly, the information supply terminal 8 has the following function. That is, the information supply terminal 8 identifies the viewer, receives channel selection information through the television program receiver by which the viewer can watch any television program voluntarily when the viewer selects a channel, generates individual audience result information for the viewer on the basis of the identification result and the channel selection information of the viewer, generates individual interest information on the basis of the individual audience result information, and transmits both the individual audience result information and the individual interest information to the service processing center 12.

In order to carry out the above-mentioned function, as shown in FIG. 2, the information supply terminal 8 is constituted by a channel selection portion 801, an access managing portion 802, an edit output portion 803, a monitor 804, an information managing portion 805, an individual audience result information file 806, an individual interest information file 807, an information generating/transmitting portion 808, a communication portion 809, a transmission/reception managing portion 810, and a viewer identification portion 800. Further, the information supply terminal 8 is connected to the television tuner 6 (having a television tuner card installed into a not-shown extended slot of the personal computer).

Incidentally, an “individual identifying potion” for identifying the individual within the scope of claim for a patent is constituted by the individual identifying portion 800. Further, a “media program receiver” is constituted by the channel selection portion 801 and the television tuner 6. Further, a “channel selection information input portion” is constituted by the access managing portion 802. An “audience result information generating portion” is also constituted by the access managing portion 802. An “interest information generating portion” is constituted by the information managing portion 805. An “information transmission portion” is constituted by the information generating/transmitting portion 808 and the communication portion 809. Incidentally, these portions are formed as software (as programs) in the information supply terminal 8 which is a computer.

Details about the portions will be described below.

The viewer identification portion 800 has a function for identifying the viewer. The viewer identification portion 800 identifies the viewer by retrieving a not-shown viewer registration table provided in the viewer identification portion 800 on the basis of the user name entered by the viewer through a not-shown keyboard of the personal computer. Viewer identification information as an identification result is supplied to the access managing portion 802. Each audience registration table is a unique table for each viewer's home.

The viewer uses the channel selection portion 801 to select television programs and the channel selection portion 801 generates channel selection information. The channel selection information generated thus is supplied to the television tuner 6 and the access managing portion 802. The television tuner 6 chooses a television program in accordance with the channel selection information. The broadcast wave received by the antenna 7 is subjected to tuning by the television tuner and supplied to the monitor 804 through the edit output portion 803. Incidentally, assume that the television program is selected by means of the not-shown keyboard or a mouse in the personal computer.

The access managing portion 802 judges whether the television program has been kept continuously without tuning for a predetermined time or longer after the television program is selected on the basis of the channel selection information and the program information. If yes, the access managing portion 802 regards the viewer is individually watching the television program on the basis of the viewer identification information. Then, the access managing portion 802 generates the individual audience result information about which viewer had watched which television program/programs, and supplies the generated information to the information managing portion 805. The individual audience result information has a logic configuration shown in FIG. 3. From the information, it can be found the result that which viewer had watched which television program at what time. The fact that Mr. A had watched “News”, “Close-Up”, “Documentary” from 7 p.m. to 9 p.m., Oct. 17, 2000 can be shown in FIG. 3 on the basis of the state of flag between “1” (watching) and “0” (not watching) in each audience section. Of course, the logic configuration of the individual audience result information in FIG. 3 is only an example. Any other logic configuration such as a configuration in which only the watched television program/programs are cited may be used. The individual audience result information is stored in the individual audience result information file 806 through the information managing portion 805 after being sorted out and classified. Further, the channel selection information is also stored in a not-shown storage area as an access history. Incidentally, the information having the access history and the viewer identification data added to the access history may be regarded as the individual audience result information.

Incidentally, the program information which will be the base for the individual audience result information is a table showing which broadcasting station 1 broadcasts which television program at what time, like a so-called program list (See FIG. 3). The program information is assumed to be periodically downloaded from the service processing center 12 and stored in a not-shown storage area in the access managing portion 802. Of course, the program information may be designed to be transmitted from the broadcasting stations 1 in a state of being superimposed on broadcast wave and stored in the access managing portion 802. Alternatively, a CD-ROM or floppy disk on which the program information is stored may be designed to be transmitted to the viewer's home 5 periodically and the viewer 5 uses the CD-ROM or floppy disk to store the program information in the access managing portion 802.

The predetermined time as the reference for making a judgment as to whether the viewer has been watching the television program or not can be set to any time such as five minutes. If the time is set to be shorter, overlooking of the information happens less. On the other hand, if the time is set to be longer, reliability of the obtained information can be enhanced. Of course, in the case where the individual audience result information is generated on the basis of the judgment, for example, both the flag states of the audience sections in “Close-Up” and “Human XX” of FIG. 3 may become 1 (watching). Alternatively, because each television program is broadcast for a fixed span of time, the flag state of the audience section may be set to “1” (watching) only if the viewer had watched the program for 60% or more of the total time span of the television program.

The edit output portion 803 has a function of receiving the individual interest information and the individual audience result information generated in the information managing portion 805, and displaying the information on the monitor 804. When the individual interest information is outputted on the monitor 804, the viewer may know where the viewer's personal interest is, judge whether the viewer is monomaniac in his/her interest or not, and grasp the viewer's favorite category. In such a manner, the viewer may develop his/her individuality and make up the lack part of his/her individuality. Further, the viewer may confirm the contents of the individual interest information and the individual audience result information in advance before the information is transmitted to the service processing center 12.

Further, the edit output portion 803 has a function of receiving point-award information, product introduction information (distribution information), product purchase procedure information, personal data transmission request information and so on, which are transmitted from the service processing center 12, through the transmission/reception managing portion 810 and a function of displaying the above information on the monitor 804. From the information, the viewer may know the fact that a point/points are awarded to the viewer, or obtain the information of a product/products in which the selling agent 14 or the like deals, or know the way to purchase the product/products. Further, personal data transmission left behind may be eliminated.

The monitor 804 is a screen of the information supply terminal 8 constituted by the personal computer having a liquid crystal display device or the like. The monitor 804 displays the television programs, or various kinds of information visually.

The information managing portion 805 has a function of sorting out the individual audience result information received from the access managing portion 802 in accordance with the viewers and has a function of storing the result information on the individual audience result information file 806. Further, the information managing portion 805 has a not-shown storage area where the television program category table (media program category storage portion) having the television programs classified into categories in advance is stored. The information managing portion 805 further has a function of retrieving the television program category table on the basis of the individual audience result information, generating the individual interest information and storing the information onto the individual interest information file 807. Further, the information managing portion 805 has a function of supplying the read individual audience result information and the read individual interest information to the edit output portion 803, while the individual audience result information stored in the individual audience result information file 806 and the individual interest information stored in the individual interest information file 807 are to be read and displayed on the monitor 804.

Incidentally, in the television program category table, the television program category is stored in associated with the television programs, such as “program A; travel, foreign, resort, marine sport, family-target, re-broadcast program . . . ”; or “program B; sport, soccer, Serie A, midnight program . . . ” (media program category table). The individual interest information is generated in various kinds of forms. With this configuration, the individual interest information is generated by retrieving the television program category table on the basis of the individual audience result. The categories of the television programs are created by the broadcasting stations 1 who are the producers of the media programs, and supplied to the undertaker or manager running the information service system. The undertaker or manager watches (edits) and creates the television programs.

FIG. 4 shows a logic configuration of Mr. A's individual interest information. This individual interest information includes items of “Education”, “Music”, “Sport”, “Travel”, “Interior”, . . . as broad categories (broad classification). Further, “Education” category has items of “English”, “French”, . . . as narrow categories (narrow classification).

For example, if the television program that the viewer Mr. A had watched is a travel television program having travels in U.S.A. as the subject, the category of the television program in the television program category table is described as “U.S.A.”, “Travel”. Accordingly, if the information managing portion 805 retrieves the television program category table on the basis of the individual audience result information and tries to add the hit category to the individual interest information, 1 point is added to the numeric field of the category “Travel” and “U.S.A.” in the individual interest information (in FIG. 4, the numerical value is 35 points). The individual interest information is aggregated every predetermined period as a report such as daily report, weekly report, or monthly report, and treated as a state of so-called histogram. Incidentally, some television programs may be long while others may be short, or some categories of the television programs may be treated lightly, compared with other categories. In such a circumstance, each category may be weighted in accordance with the watching time so as to add the point/points to the corresponding numeric field. For example, weighting may be performed such that 10 minutes is regarded as one unit for 1 point. Accordingly, if the viewer had watched for one hour, weighting is performed to add 6 points to the corresponding numeric field. That is, if judgment is made in accordance with the number of times of watching, only 1 point can be added for one time. However, if points are given in accordance with watching time, 3 points are added for watching 30 minutes and 6 points are added for watching 60 minutes even in the same case for one time of watching. Further, if a category has to be treated lightly, weighting may be performed to add the category, for example, 0.2 point. Incidentally, binarization may be performed for each numeric field of the individual interest information as follows. That is, a predetermined value is set as the threshold for the numeric field. The numeric field is flagged to “1” (interested) if it has a value not smaller than the predetermined value. On the other hand, the numeric field is flagged to “0” (not interested) if it has a value smaller than the predetermined value. Alternatively, N-arization having an integer not smaller than 2 may be performed. Further, the period of time for watching the television broadcast/broadcasts may vary in accordance with the viewers. Some viewers often watch television broadcasts while others may not (others may watch programs only when they want to watch). In this case, a threshold may be set in accordance with the viewers, or a percentage may be displayed for each viewer.

Incidentally, if it is known that the narrow category of the program “Concert” in FIG. 3 belongs to “Folk Song” in the television program category table, a point/points are added to category “Folk Song” (not shown) in category “Music” in FIG. 4. However, if it is only known that the program “Concert” belongs to category “Music”, a point/points are assigned to broad category “Music”, or equally assigned to each narrow category under broad category “Music”. In the case where a point/points are equally assigned to each narrow category under broad category “Music”, the point/points are divided by the number of items so that the divided value is assigned to each narrow category proportionally. In such a manner, assignment of a higher value to a specific item can be avoided. That is, the categories can be classified into tiers so that accuracy of the collected interest information can be improved.

The television program category table for generating the individual interest information is created by the information system or the broadcasting stations 1. Like the above-mentioned program information, the television program category table may be downloaded, superimposed on the broadcast wave, distributed by means of a medium, or the like, so that the television program category table may be stored on a storage area of the information managing portion 805. Incidentally, a different mode for generating the individual interest information will be described later. Further, if program guidance or program titles can be received by the information supply terminal 8 as electronic data, the television program category table can be generated by extracting a word/words from the program guidance or program titles.

In the individual audience result information file 806, the individual audience result information generated thus is stored (see FIG. 3). The individual audience result information file 806 is formed in a storage area of a not-shown hard disk of the information supply terminal 8.

In the individual interest information file 807, the individual interest information generated thus is stored (see FIG. 4). The individual interest information file 807 is formed in a storage area of a not-shown hard disk of the information supply terminal 8.

The information generating/transmitting portion 808 has a function of reading the individual audience result information and the individual interest information stored in the individual audience result information file 806 and the individual interest information file 807 respectively, converting the format of the above information into predetermined communication format, and making the communication portion 809 transmit the information to the service processing center 12.

The communication portion 809 has a function of performing communication on the TCP/IP (Transport Control Protocol/Internet Protocol) network. The communication portion 809 transmits the individual audience result information and the individual interest information, the format of which has been converted into the predetermined communication format, or transmits personal data to the service processing center 12 and receives information (point-award information, product introduction information, product purchase procedure information, personal data transmission request information, etc.) transmitted from the service processing center 12 to thereby supply these kinds of information to the transmission/reception managing portion 810. Hence, these kinds of information can be processed by the transmission/reception managing portion 810 and the edit output portion 803 and outputted to the monitor 804.

When the transmission/reception managing portion 810 receives the point-award information, product introduction information, and so on, from the communication portion 809, the transmission/reception managing portion 810 has a function of supplying these kinds of information to the edit output portion 803 to thereby output these kinds of information to the monitor 804. The transmission/reception managing portion 810 has also a function of managing the transmission/edit of personal data (for example, address, name, age, sex, hobby, occupation, the length of service, annual income, family structure, etc.). Therefore, the transmission/reception managing portion 810 has a not-shown operation input portion so as to input/edit the personal data. Further, the operation input portion makes the personal, as the transmission target, capable of being displayed on the monitor 804 through the edit output portion 803. Incidentally, the input/edit/display of personal data can be generally performed by the operation of a keyboard or mouse as an operation input portion.

The aforementioned information is transmitted to the service processing center 12 automatically periodically or manually. Alternatively, configuration may be made so that the service processing center 12 reads information directly by accessing the information supply terminal 8.

### Information Supply Terminal Including Exclusive Communication Terminal

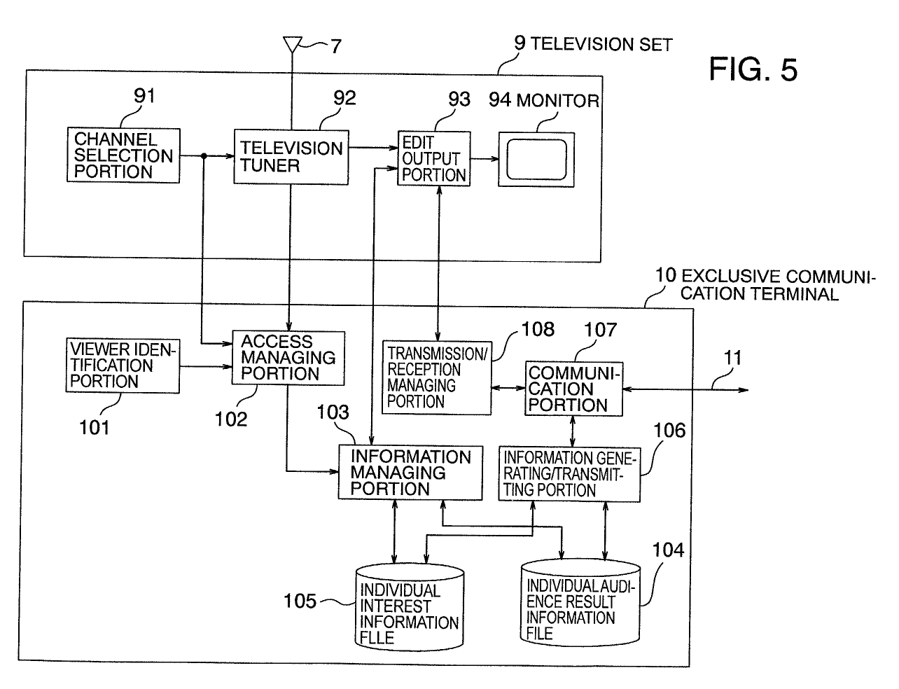

An information supply terminal 10 including an exclusive communication terminal will be described below with reference to FIG. 5.

FIG. 5 is a block diagram of a television set and an information supply terminal constituted by an exclusive communication terminal.

A combination of the information supply terminal 10 and the television set 9 has the same function as that of the information supply terminal 8 constituted by a personal computer.

Therefore, as shown in FIG. 5, the television set 9 has a channel selection portion 91, a television tuner 92, an edit output portion 93, and a monitor 94. On the other hand, the exclusive communication terminal 10 has a viewer identification portion 101, an access managing portion 102, an information managing portion 103, an individual audience result information file 104, an individual interest information file 105, an information generating/transmitting portion 106, a communication portion 107, and a transmission/reception managing portion 108. Incidentally, functions of the portions identical to those in the personal computer 8 are given to identical names correspondingly. Portions in this information supply terminal 10 which are different from those in the information supply terminal 8 constituted by a personal computer will be described hereunder.

The channel selection portion 91 is equivalent to a channel selector for the television set 9 and also equivalent to a remote controller for the television set 9.

The viewer identification portion 101 has one and the same function as that of the viewer identification portion 800 in the personal computer 8. The viewer identification portion 101 may be integrated with a remote controller equivalent to the channel selection portion 91 of the television set 9. Further, when buttons such as viewer A, viewer B, viewer C, all family members (A+B+C . . . ), etc. are provided in a remote controller or the like so that each of the buttons corresponds to a specific audience, the operation for viewer identification which needs to be made by a viewer can be omitted preferably.

The transmission/reception managing portion 108 has a function equivalent to that of the transmission/reception managing portion 810 in the personal computer 8. The entrance of personal data can be executed by a suitable method such as a method of selecting an item from items preset in a menu through ten-key operation, or a method of entering information by combination of the ten-key operation and character converting operation in the condition that characters are assigned to ten keys in the same manner as that in a cellular phone. Such ten keys may be replaced by a remote controller. Incidentally, when such ten keys are replaced by a remote controller, the following three functions, that is, (1) the function of the channel selection portion 91, (2) the function of the viewer identification portion 101 and (3) the function of entering the personal data by the transmission/reception managing portion 108 may be preferably given to the remote controller so that the number of required remote controllers can be reduced. Further, the function of the access managing portion 102 may be incorporated in the remote controller.

### Service Processing Center

The service processing center 12 will be described below with reference to FIGS. 1, 6 and 7.

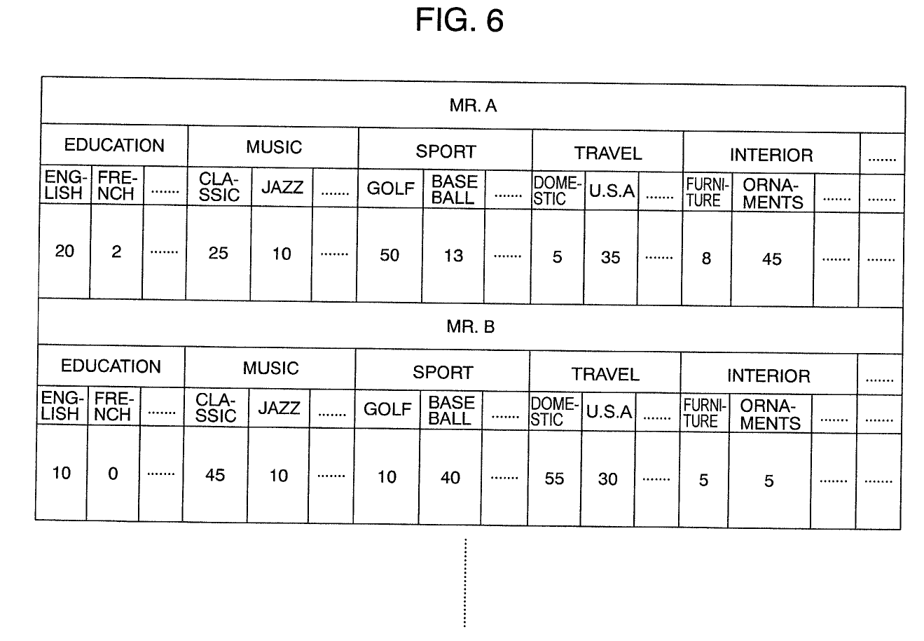

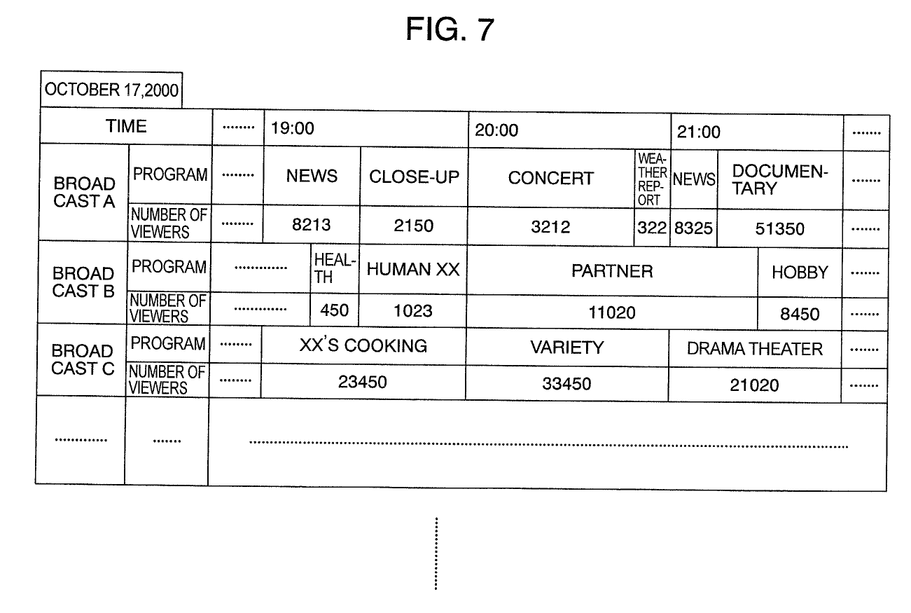

FIG. 6 is a logical configuration diagram of individual interest information in the service processing center 12. FIG. 7 is a logical configuration diagram of aggregate audience result information.

The service processing center 12 realizes an information service system which collects information from the viewers who watch television programs through a public communication network 11, gives points to the viewers in accordance with the collected information and supplies the collected information to the information users through the public communication network 11.

Therefore, as shown in FIG. 1, the service processing center 12 has a communication portion 121, an information managing portion 122, an information generating/transmitting portion 123, an individual audience result information file 124, an individual interest information file 125, an aggregate audience result information file 126, a transmission/reception managing portion 127, a personal data file 128, and an individual point file 129.

Incidentally, the “interest information input portion” in the scope of claim is constituted by the communication portion 121 and the information managing portion 122. The “file managing portion” is constituted by the information managing portion 122 and the information generating/transmitting portion 123. The “first point-awarding portion”, “second point-awarding portion” and “third point-awarding portion” are constituted by the transmission/reception managing means 127 and the individual point file 129. The “browse request responding portion” is constituted by the communication portion 121, the information generating/transmitting portion 123, the individual interest information file 125, etc. The “personal data input portion” is constituted by the communication portion 121, the transmission/reception managing portion 127 and the personal data file 128. The “audience result information aggregation portion” is constituted by the information managing portion 122. The “information output portion” is constituted by the communication portion 121, the information generating/transmitting portion 123 and the transmission/reception managing portion 127. The “distribution information input portion”, “distribution destination list input portion” and “distribution portion” are constituted by the communication portion 121 and the transmission/reception managing portion 127.

The communication portion 121 has a function of performing communication on the TCP/IP network. The communication portion 121 sends point-award notification, product introduction information, product purchase procedure information, personal data transmission request information, etc., to the information supply terminals 8 and 10. Further, the communication portion 121 receives individual audience result information, individual interest information and personal data transmitted from the information supply terminals 8 and 10. Further, the communication portion 121 can transmit/receive various kinds of information to/from the broadcasting stations 1, the advertising agent 13 and the selling shop 14 on the TCP/IP network. The communication portion 121 transmits/receives individual audience result information, individual interest information, personal data, aggregate audience result information, a point-award instruction, product introduction information, distribution destination list information, etc., to/from information-using terminals (not shown) possessed by the broadcasting stations 1, the advertising agent 13 and the selling shop 14.

Incidentally, examples of the “product introduction information (distribution information)” may include: information for giving an incentive to individual purchasing power such as supermarket bargain sale information; information for giving an incentive to mental interest such as program guidance or book guidance; information for giving an incentive to investment such as stock price information; and so on. The “distribution destination list information” is generated (created) on the basis of at least individual interest information by each information user. The information service system receives the distribution information and distribution destination list information and distributes the distribution information to each individual on the basis of the distribution destination list. Examples of the mode for distribution may include: a paper-base mode using mail service, facsimile, or the like; a voice-base mode using telephone service, or the like; an electronic database mode using information supply terminals on a network; and so on. For example, in the case of the mode using information supply terminals, distribution information can be distributed when an electronic mail having the URL (Uniform Resource Locator) of the information user's homepage written is transmitted to the information supply terminals. It is a matter of course that the URL may be written in a postal matter.

The information managing portion 122 has a function of classifying/sorting individual audience result information and individual interest information, which are transmitted from the information supply terminals 8 and 10 to the communication portion 121, into the individual audience result information file 124 and the individual interest information file 125 respectively and storing the files 124 and 125. The information managing portion 122 further has a function of aggregating individual audience result information and storing the information as aggregate audience result information in the aggregate audience result information file 126.

As shown in FIG. 6, individual interest information is stored in accordance with the viewers such as Mr. A, Mr. B, . . . FIG. 7 shows the logical configuration of aggregate audience result information. From the aggregate audience result information shown in FIG. 7, that fact that 8,213 persons are watching the “News” at 19:00 can be found. It is also found that 23,450 persons are watching the “XX's Dinner” at 19:00. The more the number of persons watch, the higher the audience share. This means that many viewers pay attention to the program.

The information generating/transmitting portion 123 has a function of reading information stored in the individual audience result information file 124, the individual interest information file 125 and the aggregate audience result file 126 and converting the format of the information into predetermined communication format. Incidentally, the information read and converted thus may be transmitted from the communication portion 121 to the information-using terminals (of the broadcasting stations 1, the advertising agent 13 and the selling shop 14) as occasion demands. The information generating/transmitting portion 123 further has a function of responding to a browse request which is made by the information-using terminals for browsing the individual interest information file 125 or the like.

Individual audience result information (see FIG. 3) is stored in the individual audience result information file 124. Individual interest information (see FIG. 6) is stored in the individual interest information file 125. Aggregate audience result information (see FIG. 7) is stored in the aggregate audience result information file 126. The respective files 124, 125 and 126 are formed in a storage area of a hard disk not shown, or the like, in the service processing center 12 which serves as a computer.

The transmission/reception managing portion 127 has a function of receiving personal data transmitted from the information supply terminals 8 and 10 through the communication portion 121 and sorting/storing the personal data into the personal data file 128. The transmission/reception managing portion 127 further has a function of receiving a point-award instruction transmitted from the not-shown information-using terminal of the advertising agent 13 or the like through the communication portion 121, and sorting/storing the instruction into the individual point file. Upon reception of such a point-award instruction, the transmission/reception managing portion 127 further has a function of generating the point-award information for a corresponding viewer and transmitting the information to the corresponding information supply terminal 8 or 10 through the communication portion 121. Further, upon reception of the point-award instruction, the transmission/reception managing portion 127 has a function of awarding a predetermined point/points to the predetermined viewer by writing the predetermined point/points assigned in accordance with the point-award instruction in the predetermined viewer's portion of the individual point file 129 (third point-awarding portion). The transmission/reception managing portion 127 further has a function of distributing (transmitting) product introduction information received from the information-using terminal to the viewers written on the distribution destination list through the communication portion 121 on the basis of the distribution destination list information received from the information-using terminal. The transmission/reception managing portion 127 further has a function of managing the interchange of information such as product purchase procedure information. The transmission/reception managing portion 127 further has a function of transmitting information such as personal data transmission request information through the communication portion 121. The transmission/reception managing portion 127 further has a function of transmitting program information, which is necessary for the information supply terminals 8 and 10 to generate individual audience result information, to the information supply terminals 8 and 10 through the communication portion 121. The transmission/reception managing portion 127 further has a function of reading personal data stored in the personal data file 128 and transmitting the personal data to the information-using terminal of the advertising agent 13 or the like through the communication portion 121. The transmission/reception managing portion 127 further has a function of responding to a browse request which is made by the information-using terminal to browse the individual interest information file 125 or the like.

Personal data are stored in the personal data file 128. The information about how many points have been already awarded to each viewer is stored in the individual point information file 129. The respective files 128 and 129 are formed in a storage area of a hard disk not shown, or the like, in the service processing center 12 which serves as a computer.

Incidentally, the service processing center 12 has a function of charging the information user (such as each of the broadcasting stations 1, the advertising agent 13 or the selling shop 14) the fee for the supply of information. Whenever information is supplied to the information user, charging information is written in a record in association with the information user in an information user charging file (not shown) storing a list of information users to thereby charge the information user. A bill is issued to the information user on the basis of the information user charging file and actual money (price) payment is then performed by transferring the charge from the user's bank account or the like. The service processing center 12 further has an authentication function, so that no information is transmitted/received to/from an information-using terminal which has been not authenticated yet. Incidentally, the service processing center 12 need not be centralized to a single computer (server), that is, it is a matter of course that the service processing center 12 may be constituted by a plurality of computers distributed on a network.

### Information-Using Terminal

The information-using terminal will be described.

The information-using terminal possessed by an information user such as each of the broadcasting stations 1, the advertising agent 13 or the selling shop 14 is constituted by a personal computer not shown, or the like. The information-using terminal has a function of communicating with the information supply terminals 8 and 10 and the service processing center 12 on the TCP/IP network. The information to be transmitted/received is individual audience result information, individual interest information, aggregate audience result information, personal data, a point-award instruction, product introduction information (distribution information), distribution destination list information, product purchase procedure information, and so on, as described above. The information-using terminal further has a function of retrieving individual interest information or the like stored in the service processing center 12. This function is generally achieved by a browsing software (browser) application.

### Mode of Transmission/Reception of Information

Incidentally, there is a mode in which transmission of various kinds of information from the service processing center 12 to the information supply terminals 8 and 10 or to the information-using terminals is performed by electronic mail. There is also a mode in which such transmission is performed in response to transmission requests made by the information supply terminals 8 and 10 or from the information-using terminals. There is a further mode in which such transmission is performed on the basis of IP (Internet Protocol) addresses assigned to the terminals respectively when the information supply terminals 8 and 10 and the information-using terminals are always connected to the public communication network 11. Also transmission of information from the information supply terminals 8 and 10 or from the information-using terminals to the service processing center 12 can be performed in any one of modes similar to the aforementioned modes. Incidentally, assume that the service processing center 12 is always connected to the public communication network 11 and has a fixed IP address. Assume further that the service processing center 12 has an URL, and the transmission/reception of these kinds of information is performed by an HTTP (Hyper Text Transfer Protocol) which forms the base for transmission/reception of information on Internet.

### Mode of Information Service

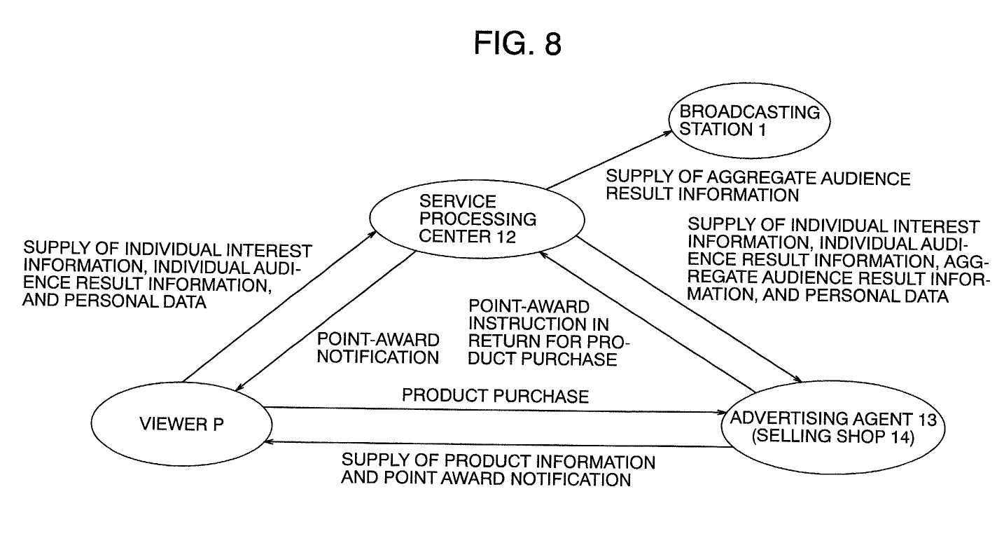

The mode of information service will be described below with reference to FIG. 8 (in connection with FIG. 1 or the like).

FIG. 8 is a diagram for explaining the mode of information service.

When each of individual persons P who watches a television program/programs transmits individual interest information and individual audience result information to the service processing center 12, the service processing center 12 transmits aggregate audience result information to the broadcasting stations 1 and transmits the individual interest information, the individual audience result information and the aggregate audience result information to the advertising agent 13 or the selling shop 14 (hereinafter referred to as “advertising agent 13 or the like”). A point/points as an award for the supply of information from the viewer P are given to the viewer P. In awarding such a point/points, for example, the service processing center 12 may send point-award notification to the viewer P by an electronic mail, a postal matter or the like. Hence, the viewer P can receive a certain product free of charge when such points reach a certain value.

Incidentally, the points can be received in any one of various modes. For example, point receiving means may include an IC card, an electronic purse, a storage in a personal computer or a cellular phone, or the like. When the points (coupons) are awarded through Internet facsimile or the like (in a paper mode), a facsimile receiving function or the like can be applicable to the point receiving portion.

The advertising agent 13 or the like supplies product information for introducing a product/products for sale to each viewer by an electronic mail, a postal matter or the like on the basis of individual interest information, individual audience result information and aggregate audience result information given from the service processing center 12. If there is no supply of individual interest information and/or individual audience result information from the viewer P, the advertising agent 13 or the like judges a product/products which are conceived to be likely to be purchased by a lot of consumers on the basis of the title, category, keyword or content of the television program stored in the aggregate audience result information so as to introduce the product/products to the viewer P. When the viewer P purchased the introduced product, the advertising agent 13 or the like notifies the service processing center 12 of the point/points corresponding to the purchased product in order to add the point/points for the purchased product to the accumulated points in association with the viewer P. This point information is also given to the viewer P. The advertising agent 13 or the like may supply information about a point/points corresponding to each product to an individual person when the product is introduced to the individual person because there is the possibility that the supply of the point information may make the individual person want to purchase the product.

Upon reception of the notification of the point/points for the purchased product, the service processing center 12 adds the point/points to the accumulated points of the viewer P and notifies the result of the viewer P. Hence, the advertising agent 13 or the like can introduce a product/products to each viewer P on the basis of information concerning individual interest or can easily decide the advertisement of a product/products likely to be purchased by a lot of consumers. On the other hand, on the basis of the supplied aggregate audience result information, the broadcasting stations 1 can easily determine/select commercials broadcast in a television program having a large number of viewers and easily set charges for the commercials broadcast in the television program.

### Detailed Mode of Information Service

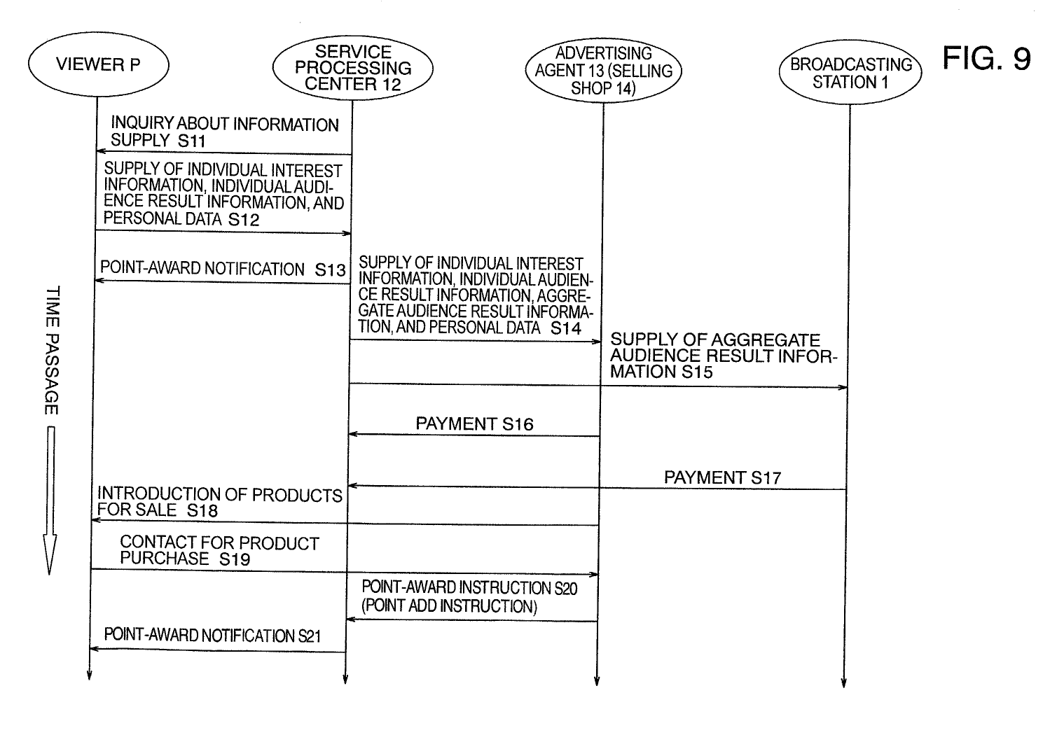

The detailed mode of information service will be described with reference to FIG. 9 (in connection with FIG. 1 or the like).

FIG. 9 is a sequence diagram for explaining the detailed mode of information service.

First, the service processing center 12 sends each viewer P inquires about supply of the viewer's individual interest information, individual audience result information and personal data (for example, address, name, age, sex, hobby, occupation, the length of service, annual income, family structure, etc.) (S11). In response to the inquires, the viewer P transmits the individual interest information and the individual audience result information generated by the information supply terminals 8 and 10 in accordance with the viewed television program/programs, and transmits personal data entered by the viewer P, if necessary, to the service processing center 12 (S12). Assume now that personal data are also supplied. Upon reception of the individual interest information, the individual audience result information and the personal data from each viewer P, the service processing center 12 notifies the viewer P of points awarded for prize service (S13). The service processing center 12 further supplies the individual interest information, the individual audience result information, the aggregate audience result information and the personal data to the advertising agent 13 or the like (S14). The service processing center 12 also supplies the aggregate audience result information to the broadcasting stations 1 (S15). Each of the broadcasting stations 1 and the advertising agent 13 or the like pays the fee for the supply of these kinds of information to the service processing center 12 (S16 and S17). The advertising agent 13 or the like introduces a product/products for sale, which are likely to be purchased by the viewer P, to the viewer P on the basis of the viewer's individual interest information and individual audience result information or the aggregate audience result information (S18). If the viewer P desires to purchase the introduced product, the viewer P makes contact with the advertising agent 13 or the like to purchase the product (S19). The advertising agent 13 or the like sends the service processing center 12 of point-award notification (point-award instruction) (S20) and notifies the viewer P of the point/points to be added (S21) in order to give the viewer P the point/points as an award for the purchase of the product. Incidentally, when the viewer does not personally supply his/her individual interest information and/or individual audience result information so that the advertising agent 13 or the like cannot obtain the individual audience result information, the advertising agent 13 may introduce a product/products, which are likely to be purchased by a lot of consumers on the basis of statistically processed audience result information, to the individual person.

Alternatively, the introduction of the product/products for sale to the viewer P in the step S18 may be performed by the service processing center 12 if the product introduction information and the distribution destination list information are transmitted from the advertising agent 13 or the like to the service processing center 12. Further, the contact to purchase the product in the step S19 may be performed through the service processing center 12. In such a manner, the service processing center 12 can collect various kinds of information.

Incidentally, it is known well that the way of awarding (issuing) a point/points or a coupon/coupons has an influence on the sale of the product/products. How to award points has a significant meaning to product suppliers (information users) in mapping out business strategies. According to the third point-awarding portion, a point/points can be awarded on the basis of the point-award instruction. Hence, a point/points can be awarded regardless of the first and second point-awarding portions, for example, in accordance with the business strategy of the advertising agent 13 or the like.

### Processing Flow of Information Service

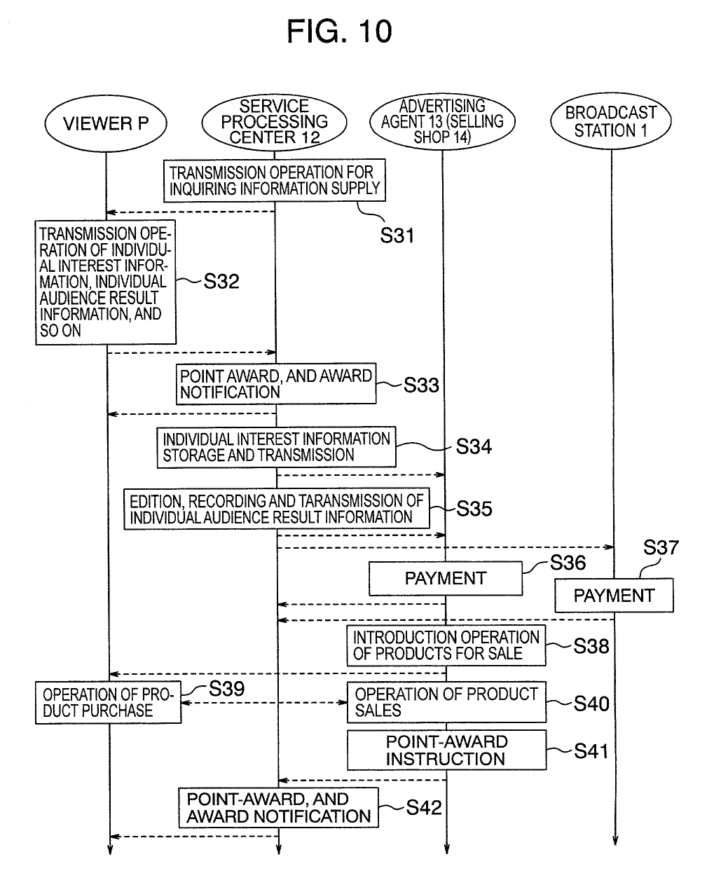

A processing flow of information service will be described below with reference to FIG. 10.

FIG. 10 is a sequence diagram for explaining a processing flow of information service.

The service processing center 12 makes transmission operation to inquire each television program viewer P about the supply of his/her individual audience result information, individual interest information and personal data (S31). In response to the inquiries, the viewer P performs operation to call corresponding information from the individual audience result information file 806, and the individual interest information file 807 of the information supply terminal 8 and to transmit the information in order to supply (transmit) the individual audience result information and/or the individual interest information to the service processing center 12 (S32). When the supply of the personal data is requested in the step S31, the viewer P generates (updates) the personal data in the information supply terminal 8 and transmits the personal data to the service processing center 12 as occasion demands (S32).

When the service processing center 12 receives the individual interest information, the individual audience result information and/or the personal data from the viewer P, the service processing center 12 awards the viewer P a point/points to grant the prize service to the viewer P, and sends point-award notification to the viewer P (S33). In the award of the points, for example, setting is done so that higher points are awarded for the individual interest information than for the individual audience result information, or higher points are awarded, for example, if age, address, sex, hobby, occupation, length of service, annual income, family structure, and so on, besides E-mail address and name are supplied as the personal data. Incidentally, in this embodiment, length of service, annual income, family structure, and so on, are valuable data for the advertising agent 13 or the selling shop 14 (hereinafter referred to as “advertising agent 13 or the like”) to look into introduction or sales of products. Accordingly, such data are set to have higher points. That is, higher points are awarded to the viewer P if the viewer P supplies data more relating to personal privacy and especially important to introduction or sales of products or if the number of such data items is larger (second point-awarding portion). In addition, the points may be increased in accordance with the number of times of supply of new information or the price range of a product group indicated by the supplied information.

Further, the service processing center 12 records the individual interest information, and supplies (transmits) the individual interest information and the personal data to the advertising agent 13 or the like (S34). In addition, the service processing center 12 records and edits the individual audience result information to compose aggregate audience result information. Then, the aggregate audience result information is recorded by the service processing center 12 and transmitted to the advertising agent 13 or the like (S35). The aggregate audience result information is also transmitted to the broadcasting stations 1 (Step 35). The advertising agent 13 or the like, and the broadcasting stations 1 pay the fee for the supplied information to the service processing center 12 (S36, S37). The advertising agent 13 or the like operates on the basis of the transmitted information so as to introduce each viewer P a product/products for sale which are likely to be purchased by the viewer P individually (S38). Specifically, the advertising agent 13 or the like generates product introduction information and a distribution destination list, and transmits the information and list to the service processing center 12. Then, on the basis of the distribution destination list, the service processing center 12 distributes the product introduction information to the viewers P (information supply terminals 8 and 10) registered in the distribution destination list.

When one of the viewers P watching the product introduction information wants to purchase the product, the viewer P operates to purchase the product from the advertising agent 13 or the like, and the advertising agent 13 or the like operates to sell the product to the viewer P (S39 and S40). After that, the advertising agent 13 or the like transmits a point-award instruction from an information-using terminal to the service processing center 12 in order to award a point/points to the viewer for rewarding the purchase of the product (S41). In response to this point-award instruction, a portion corresponding to that viewer P in the individual point file 129 of the service processing center 12 is rewritten (Point Award). In addition, point-award notification is sent from the service processing center 12 to the viewer P (information supply terminal 8 or 10).

Information obtained from the viewed media programs by individual persons reflects individual interest directly and has an extremely high value for utilization. That is, with such a configuration, an undertaker (service processing center 12) or the like can obtain answers to a questionnaire of individual interest as individual interest information without sending any copy of the questionnaire.

Incidentally, in the age of multichannel broadcasting such as BS broadcasting, CS broadcasting, CATV broadcasting, Internet broadcasting, etc., different from the age of so-called limited-channel broadcasting such as conventional surface wave broadcasting (for example, seven channels in the Tokyo district), any viewer can view a desired program voluntarily if the viewer selects a channel. This means that there fades away a habitual audience pattern with which a viewer “views a program reluctantly not because it is a desired program but because there are no programs on the other channels that the viewer desires to view”. That is, since the viewer can view any desired program voluntarily if the viewer selects a channel, the viewer can view a really desired program or a really interesting program. Therefore, information obtained from the viewed broadcast media has a much higher value to reflect individual taste or interest than that obtained in the conventional case.

### Information Transmission Screen in Information Supply Terminal

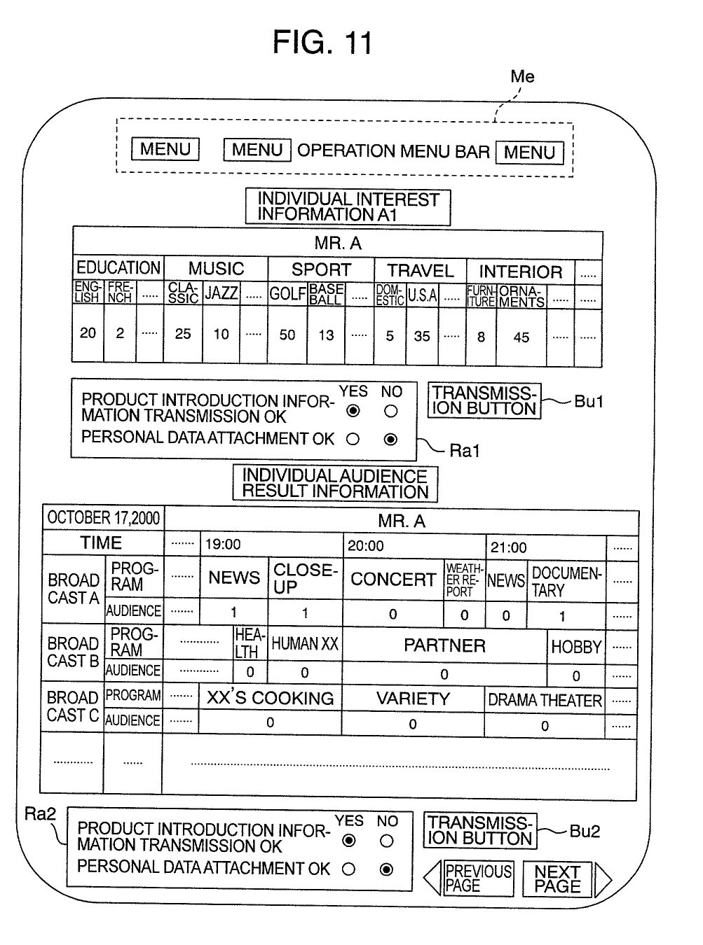

The configuration of an information transmission screen in the information supply terminal will be described with reference to FIG. 11.

FIG. 11 is a diagram for explaining the configuration of the information transmission screen of the information supply terminal.

Various menus are allocated to an operation menu bar Me. For example, such menus include transmission of only individual interest information, transmission of only individual audience result information, transmission of individual interest information and individual audience result information, product purchase procedure processing, point display, introduction of products exchangeable for points; creation/edit of personal data, and so on. FIG. 11 shows an example of the transmission of individual interest information and individual audience result information. In this example, the individual interest information shown in FIG. 4 is transmitted as interest information A1 of a person (Mr. A). On this screen, there is provided a radio button Ra1 for making setting as to whether the individual person accepts product introduction information transmission (direct mail transmission) on the basis of the individual interest information or whether the individual person accepts personal data attachment. In this radio button Ra1, the item “YES” has been checked for product introduction information transmission OK. On the other hand, the item “NO” has been checked for personal data attachment OK. In this state, when a transmission button Bu1 is clicked by a mouse (Remote Control Selection), the individual interest information of Mr. A and the information of product introduction information transmission OK are transmitted to the service processing center 12, while the personal data of Mr. A is not attached. If the item “YES” is checked for the personal data attachment OK of the radio button Ra1, the personal data of Mr. A is attached to the individual interest information and transmitted to the service processing center 12. Incidentally, default values of the radio button Ra1 are set so that the items “YES” and “NO” are checked for the product introduction information transmission OK and the personal data attachment OK respectively. The default values may be set so that the item “YES” is checked for the personal data attachment OK.

The individual audience result information in the lower column of FIG. 11 shows an example in which the individual audience result information of Mr. A in FIG. 3 is transmitted. In the same manner as that for the transmission of the individual interest information, there is provided a radio button Ra2 for the transmission of the individual audience result information so that setting as to whether the individual person accepts product introduction information transmission (direct mail transmission) on the basis of the individual audience result information or whether the individual person accepts personal data attachment can be made. In this radio button Ra2, the item “YES” has been checked for product introduction information transmission OK. On the other hand, the item “NO” has been checked for personal data attachment OK. In this state, when a transmission button Bu2 is clicked by a mouse (Remote Control Selection), the individual audience result information of Mr. A and the information of product introduction information transmission OK are transmitted to the service processing center 12, while the personal data of Mr. A is not attached. If the item “YES” is checked for the personal data attachment OK of the radio button Ra2, the personal data of Mr. A is attached to the individual interest information and transmitted to the service processing center 12. Incidentally, default values of the radio button Ra2 are also set so that the items “YES” and “NO” are checked for the product introduction information transmission OK and the personal data attachment OK respectively. The default values may be set so that the item “YES” is checked for the personal data attachment OK.

### Point Award Information Display Screen of Information Supply Terminal

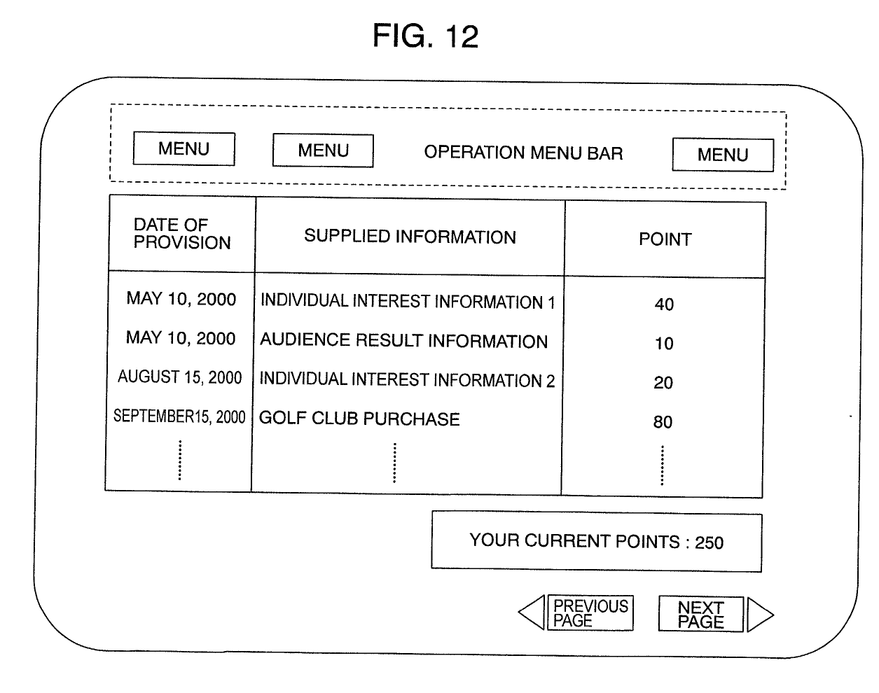

A point-award information display screen of the information supply terminal will be described with reference to FIG. 12.

FIG. 12 is a diagram for explaining the configuration of the point-award information display screen of the information supply terminal.

The point-award information transmitted from the service processing center 12 is displayed on a monitor 804 or 94 of the information supply terminal 8 or 10 as shown by the screen in FIG. 12. On this screen, there are shown not only points for the supply of individual audience result information and points for the supply of individual interest information but also points awarded for the purchase of a product (purchase of a golf club) in response to product introduction information from the advertising agent 13 or the like. Here, the points awarded on May 10, 2000 were different from those on Aug. 15, 2000 though both of them were awarded for the supply of individual interest information. This is because the supply of the individual interest information on May 10, 2000 was carried out with the attachment of personal data. Thus, the supply acquires high points of 40. In addition, since the golf club was purchased in response to the product introduction information, 80 points were awarded. Thus, total point (250 points) is also displayed.

The personal data varies in accordance with the individual circumstances of the viewer. For example, points are additionally awarded for annual update. Though not shown on the screen, introduction of products exchangeable for points can be displayed by selecting the menu. Since various products exchangeable for the total point can be seen, there is a possibility that pleasure increases much more and the chance of sales of products increases by introducing the products.

### Modification of Individual Interest Information Generating Portion

In the above-mentioned embodiment, individual interest information is generated by downloading a TV program category table in which TV programs are classified into categories in advance.

Independently, the processing of context comprehension or meaning comprehension may be applied to the contents of a TV program so as to judge the category of the TV program. As the processing of context comprehension or meaning comprehension, there are various disclosed techniques. For example, a commercially available context comprehension software tool which automates all the intellectual operations for reading and understanding a document and extracting knowledge or indexes of knowledge is applicable. Such a context comprehension software tool can be applied to arrange the interest information generating portion as a voice input portion for inputting voice of a TV program, a textualization portion for textualizing the input voice as a text, a context comprehension portion for comprehending the context of the text, and an interest information extraction portion for extracting interest information on the basis of the context comprehension.

The software tool for inputting voice and textualizing the input voice is a general technique as preinstalled in commercially available personal computers. On the other hand, the above-mentioned context comprehension software tool is applicable as the context comprehension portion. Further, if the context is comprehended, it is easy to extract what category the TV program belongs to. With such a configuration, it is not necessary to download a program category table in advance. Therefore, there is no problem that individual interest information cannot be generated because download of such a program category table is forgotten. In addition, it is not necessary to superimpose the program category table on a broadcast wave or to attach the program category table to a header of broadcast data. First of all, labor is not required for creating the program category table. In addition, even if the broadcast schedule of TV programs is changed suddenly, individual interest information can be generated without trouble.

In addition, for example, assume that there was broadcast a documentary program the content of which was “The Life Of Eiji Bando Active As Baseball Commentator, TV Personality, Program Host, And Actor After Leaving Baseball Player On The Active List”. Even if the program on the program category table is merely described as “baseball”, it is comprehended by the interest information generating portion based on the context comprehension that the program is not a baseball program. In addition, it can be judged that the viewer is interested not in baseball of sports but in Eiji Bando, baseball commentators, TV personalities, program hosts, or actors. In this case, Eiji Bando, baseball commentators, TV personalities, program hosts, or actors are set as individual interest information.

In addition, by the interest information extracting portion based on the context comprehension, individual interest information can be generated without any problem even when contents (media programs) recorded in video tape or DVD are viewed or when contents are viewed by VOD (Video On Demand) or the like. That is, individual interest information can be generated not only from contents viewed along programs such as TV programs but also from contents viewed irregularly such as personal broadcast programs on Internet, in the same manner as that performed in the regular TV programs.

### Modification of Media Program

Although media programs were regarded as TV programs in the above-mentioned embodiment, not to say, such TV programs include Internet broadcast programs. In addition, such media programs may include contents based on VOD or stored in video tape or DVD. In addition, Internet homepages (images, video, voice, text) can be included in such media programs. This is because the viewer can select to make access to any homepage of the viewer's own will, and individual interest information can be generated on the basis of the access history. In this case, individual interest information can be generated if a program category table as described above is prepared in advance. Alternatively, interest information can be generated by the above-mentioned processing of context comprehension or meaning comprehension. For example, when a text is described on a homepage, individual interest information can be generated by an interest information generating portion constituted by a text input portion, a context comprehension portion for comprehending the context of the text, and an interest information extracting portion for extracting interest information on the basis of the context comprehension.

### Modification of Point

In addition, as for a point/points, each of the information supply terminals 8 and 10 may have an IC card reader/writer to award a point/points to an IC card given to a viewer, so that the viewer can use the point/points through the IC card. Alternatively, a point-awarding apparatus for storing points in an IC card may be provided in a shop or the like. Alternatively, the viewer may make access to the service processing center 12 through an Internet-accessible cellular phone or the like. In this case, the viewer can show a clerk or the like of the selling shop 14 the screen of the cellular phone displaying the accumulated point/points or a coupon/coupons, so as to use the point/points or the coupon/coupons. Alternatively, in the case where the selling shop 14 has its own point system, when individual interest information or the like is inputted from a viewer, points may be awarded as follows. That is, a point issue instruction is given from the service processing center to the point system (point managing server) belonging to the selling shop 14. In response to the point issue instruction, the point system of the selling shop 14 writes point data in association with the viewer. Then, the service processing center 12 may send the viewer point-award notification such as “Points usable in a selling shop 14 were issued. Please use these issued points to do some shopping.” Alternatively, a coupon ticket or a magnetic card storing the accumulated points may be issued by a postal matter.

The present invention described above can be modified and carried out broadly without being limited to the above-mentioned embodiment and modifications.

For example, individual interest information may be generated on the side of the service processing center (information service system). In addition, product introduction information and information responding thereto may be distributed without the aid of the service processing center. In addition, the information supply terminal program for making a personal computer function as an information supply terminal may be distributed in the mode of downloading a program from the service processing center to the information supply terminal on a public communication network. Alternatively, the information supply terminal program may be distributed by use of storage media such as CD-ROMs. Alternatively, the information supply terminal program may be sold to be preinstalled or bundled in personal computers or cellular phones functioning as computers.

In addition, although a public network assumed was Internet, the present invention is applicable to two-point connection based on Point to Point. In addition, not only is the information supply terminal constituted by a personal computer, but also the information supply terminal may be formed integrally with a mobile apparatus such as a cellular phone or PDA. From now on, it is considered that Internet-accessible mobile apparatus or TV-broadcast viewable mobile apparatus will be widespread dramatically. It will be very convenient if such a mobile apparatus is provided with a function as an information supply terminal. In addition, an embodiment in which a mobile apparatus stores only channel selection information, and the channel selection information is data-transferred to a personal computer so that the personal computer generates interest information, also belongs to the technical scope of the present invention. That is, like the description made about the service processing center, the information supply terminal does not have to be formed into one unit, but has a distributed arrangement. In addition, a viewer identification result may be attached to the channel selection information so as to form individual audience result information, which is transmitted to the service processing center in real time.

In addition, although description was made on the assumption that information users were defined as the broadcast stations 1, the advertising agent 13 and the selling shop 14, the information users may include research companies, makers, trading companies, distributors, network undertakers, media-related enterprises other than broadcast stations, etc.

In addition, a point/points have a function as quasi-currency. Typically, an example of the point/points is the one frequently used in a discount shop of household appliances or the like. Such a point/points include a coupon/coupons playing a role as a discount ticket/tickets, a complimentary ticket/tickets, or a gift certificate/certificates. A point/points are awarded in accordance with the supply of individual audience result information, the supply of individual interest information, the supply of personal information, the purchase of a product, and so on, in various awarding modes.

In addition, information supplied to the information service system or information derived thereby is outputted (supplied) to each information-using terminal in various modes such as a push technology. For example, there are (1) a mode in which the information is outputted to the information supply terminal by an electronic mail; (2) a mode in which the information is outputted by calling the information-using terminal by Point to Point communication; (3) a mode in which the information is outputted on the basis of an IP address of the information-using terminal in such a case that the information-using terminal is connected to Internet around the clock; and so on. The output is carried out whenever information is inputted or updated, or whenever a predetermined period has passed. For example, the information to be outputted includes aggregate audience result information, an audience share, and so on, derived from the individual interest information or the individual audience result information.

According to the present invention described above, it is possible to obtain individual interest information as results of the viewed media programs by individual persons. This individual interest information reflects individual interest directly to thereby have an extremely high value for utilization. This information service system can collect such valuable information without effort. In addition, there is no burden on individual persons who supply information. In addition, since the individual interest information which reflects individual interest directly has an extremely high value to be used as marketing information as described above, the individual interest information becomes valuable data, for example, when a selling shop or the like offers various kinds of service to the individual persons. That is, such information becomes valuable in selling products, making business plans or the like.

In addition, each information user can browse the individual interest information by use of an information-using terminal without any trouble. Therefore, it becomes extremely easy for the information user to make access to the information. It is possible for the information user to offer more suitable service to the individual persons as the information user makes access to the information more easily.

In addition, it is possible to input valuable personal data. Since points are awarded in accordance with the contents of the personal data, it is also possible to collect more private personal data.

In addition, individual interest is grasped surely on the basis of categories of media programs, so that the individual interest information can be generated.

In addition, an aggregated value obtained by aggregating the individual audience result information shows the number of accesses to a media program. An audience share can be obtained from the aggregated value. If this information service system is applied to all the broadcast media, it is possible to obtain not a conventional audience share limited in TV broadcasts in a narrow sense, but the degree of attention in all the media. In addition, this aggregated value becomes a reference value for computing a charge when a commercial is placed or broadcast in a media program.

In addition, information supplied to the information service system or information derived thereby is outputted (supplied) to each information-using terminal in a push technology such as a direct mail. Therefore, an information user can obtain information without trouble.

In addition, points can be awarded on the basis of the business strategy of the information user.

In addition, it becomes easy for individual persons and an undertaker to receive and award the points respectively. If the points are received and awarded easily, the possibility that the points will be utilized becomes high. This brings a great benefit to the information user who plans to increase sales by awarding the individual persons points. In addition, it is also possible to give a variation to the utilization modes for the points.

In addition, information about affairs in which individual persons are interested is distributed to the individual persons. That is, it must take time and effort to obtain information about interesting affairs. However, according to the present invention, information about interesting affairs is distributed (transmitted) as distribution information by the information service system. Thus, the individual persons can save time and effort. On the other hand, not only do the information users save the trouble of distributing the information but also vain information distribution can be avoided. Accordingly, the information business system assists the businesses of the information users largely. That is, for example, an advertising agent, a selling shop, or the like, can supply information of products appropriate to the interests of the individual persons so as to sell the products efficiently.

In addition, it is possible to function the terminal of the individual person as an information supply terminal in the information service system surely, and it is possible to generate individual interest information surely. When a text is contained in a media program, individual interest information can be generated from this text on the basis of context comprehension. At this time, information in which media programs have been classified into categories is not required especially. It is therefore possible for an undertaker or the like to obtain individual interest information without any trouble. Incidentally, the present invention can be applicable to Internet homepages or teletext broadcasting. In addition, when voice is included in a media program, it is possible to generate individual interest information from this voice on the basis of context comprehension. Also in this case, information in which media programs have been classified into categories is not required especially. It is therefore possible for an undertaker or the like to obtain individual interest information without trouble. For example, it is possible to recognize a new interest which has not been found out. In addition, it becomes easy and sure to receive a point/points, and it becomes easy to deal with the point/points. In addition, since context comprehension is carried out on the basis of at least voice data of a media program, it is also possible to generate individual interest information by only the voice data.

In addition, it is possible to obtain individual interest information as a result of the viewed media programs from individual persons, and the individual persons can obtain points in return.

In addition, it is possible to function a computer as an information supply terminal surely.

1. An information service system in which information is collected, on a predetermined network, from individual persons who watch media programs and points are awarded to the individual persons in accordance with the collected information, comprising:
at least one of an interest information generating portion and an interest information input portion, said interest information generating portion being designed so that individual audience result information generated as results of media programs watched by said individual persons is inputted in information supply terminals existing on said network and individual interest information is generated on the basis of said individual audience result information, said interest information input portion being designed so that said individual interest information generated as said results of media programs watched by said individual persons is inputted in said information supply terminals;
a file managing portion for managing a file of at least said individual interest information; and
a first point-awarding portion for awarding a predetermined point/points to each of said individual persons correspondingly to supply of said individual audience result information or supply of said individual interest information from said individual person.

2. An information service system according to claim 1, further comprising:
a browse request responding portion for allowing browse of said file in response to a browse request made by each of information-using terminals existing on said network; and
a charging information generation portion for generating charging information for each of information users browsing said file.

3. An information service system according to claim 1, further comprising:
a personal data input portion for receiving, as personal data, information about a media program/programs watched by each of said individual persons, from corresponding one of said information supply terminals; and
a second point-awarding portion for awarding a predetermined point/points to said individual person in accordance with contents of said received personal data.

4. An information service system according to claim 1, further comprising a media program category storage portion for storing a category of each media program in association with said media program, wherein said individual interest information is generated by retrieving said media program category storage portion on the basis of said individual audience result information.

5. An information service system according to claim 1, further comprising an audience result information aggregating portion for aggregating said inputted individual audience result information.

6. An information service system according to claim 2, further comprising an information output portion for supplying said information-using terminals existing on said network with at least one of said inputted information and information derived from said inputted information.

7. An information service system according to claim 2, further comprising a third point-awarding portion for awarding a predetermined point/points to each of said individual persons in accordance with a point-award instruction from each of said information-using terminals.

8. An information service system according to claim 1, wherein said system has a configuration so that the point award is performed electronically on said network.

9. An information service system according to claim 2, further comprising:
a distribution information input portion for receiving, from each of said information-using terminals, distribution information produced by corresponding one of said information users for a purpose of distributing said distribution information to said individual persons;
a distribution destination list input portion for receiving, from said information-using terminal, a distribution destination list of said distribution information produced by said corresponding information user on the basis of at least said individual interest information; and
a distribution portion for distributing said distribution information on the basis of said distribution destination list.

10. An information supply terminal for use in an information service system in which information is collected, on a predetermined network, from individual persons who watch media programs and points are awarded to the individual persons in accordance with the collected information, said information supply terminal comprising:
an individual identification portion for identifying an individual person;
a channel selection information input portion for inputting channel selection information through a media program receiver by which said individual person can watch a desired media program voluntarily when said individual person selects a channel;
an audience result information generating portion for generating individual audience result information on the basis of an individual identification result and said channel selection information;
an interesting information generating portion for generating individual interest information on the basis of said individual audience result information; and
an information transmission portion for transmitting at least one of said individual audience result information and said individual interest information to said information service system.

11. An information supply terminal according to claim 10, in which said interest information generating portion generates said individual interest information, on the basis of said individual audience result information, by searching a media program category storage portion in which a category of said media program is stored in association with said media program.

12. An information supply terminal according to claim 10, in which said interest information generating portion includes:
a text input portion for inputting a text of said media program;
a context comprehension portion for performing context comprehension of said text; and
an interest information extracting portion for extracting interest information on the basis of said context comprehension;
whereby said interest information generating portion generates said individual interest information.

13. An information supply terminal according to claim 10, in which said interest information generating portion includes:
a voice input portion for inputting a voice of said media program;
a textualization portion for textualizing said inputted voice as a text;
a context comprehension portion for performing context comprehension of said text; and
an interest information extracting portion for extracting interest information on the basis of said context comprehension;
whereby said interest information generating portion generates said individual interest information.

14. An information supply terminal according to claim 10, further comprising a signal conversion portion for converting said individual interest information into a signal which can be displayed on a monitor of said media program receiver.

15. An information supply terminal according to claim 10, further comprising a point receiving portion for receiving a point/points when said point/points are awarded on said network.

16. An information supply terminal according to claim 10, in which said information supply terminal is integrally configured with a television set which serves as said media program receiver, a personal computer, or a mobile apparatus.

17. An information supply terminal for use in an information service system in which information is collected, on a predetermined network, from individual persons who watch media programs and points are awarded to the individual persons in accordance with the collected information, said information supply terminal comprising:
an individual identification portion for identifying an individual person;
a voice data input portion for inputting at least voice data in a media program receiver by which a desired media program can be watched voluntarily if said individual person selects a channel;
a context comprehension portion for performing context comprehension of said voice data;
an interest information extracting portion for extracting interest information on the basis of said context comprehension;
an individual interest information generating portion for generating individual interest information on the basis of a individual identification result and said interest information; and
an information transmission portion for transmitting said individual interest information to said information service system.

18. An information service method comprising the steps of:
collecting, from individual persons who watch media programs, information about the watched media programs by said individual persons;
performing file management on a file of said collected information including at least individual interest information; and
awarding a predetermined point/points to each of said individual persons in accordance with the collected information.

19. A computer program product for use in an information supply terminal, comprising a computer, in order to make the information supply terminal be capable of being used in an information service system in which information is collected, on a predetermined network, from individual persons who watch media programs, and points are awarded to said individual persons in accordance the collected information, said computer including:
an individual identification portion for identifying an individual person;
a channel selection information input portion for inputting channel selection information through a media program receiver by which said individual person can watch a desired media program voluntarily if said individual person selects a channel;
an audience result information generating portion for generating individual audience result information on the basis of an individual identification result and said channel selection information;
an interest information generating portion for generating individual interest information on the basis of said individual audience result information; and
an information transmission portion for transmitting at least one of said individual audience result information and said individual interest information to an information collecting server provided in said information service system.
